(19) United States
(12) Patent Application Publication
(10) Pub. No.: US 2025/0046954 A1
(43) Pub. Date: Feb. 6, 2025

(54) POROSITY OF A BATTERY SEPARATOR

(71) Applicant: Apple Inc., Cupertino, CA (US)

(72) Inventors: Yanning Song, Cupertino, CA (US); Jinjun Shi, San Jose, CA (US)

(21) Appl. No.: 18/383,577

(22) Filed: Oct. 25, 2023

Related U.S. Application Data
(60) Provisional application No. 63/530,593, filed on Aug. 3, 2023.

(51) Int. Cl. H01M 50/491; H01M 10/04; H01M 50/449

(52) U.S. Cl. CPC H01M 50/491; H01M 10/0431; H01M 50/449

(57) ABSTRACT

A separator of a battery cell includes first pores disposed through a first segment of a thickness of the separator, and second pores disposed through a second segment of the thickness. In an unwound state of the separator, a first cross-sectional area of the first pores differs in size from a second cross-sectional area of the second pores by a first amount. In a wound state of the separator, the first cross-sectional area is substantially equal in size to the second cross-sectional area, or the first cross-sectional area differs in size from the second cross-sectional area by a second amount that is less than the first amount.

### CROSS-REFERENCE TO RELATED APPLICATIONS

This application claims priority to and the benefit of U.S. Provisional Application No. 63/530,593, filed Aug. 3, 2023, entitled “POROSITY OF A BATTERY SEPARATOR,” the disclosure of which is incorporated by reference herein in its entirety for all purposes.

### BACKGROUND

The present disclosure relates generally to batteries, and more specifically to battery separators.

A battery cell, such as rechargeable or secondary battery cell, may include at least one positive electrode (e.g., an anode), negative electrode (e.g., a cathode), separator between the positive electrode and the negative electrode, and electrolyte, among other features. The electrolyte fills pores of the positive electrode, the negative electrode, and/or the separator to support ionic movement between the positive and negative electrode during charging and discharging of the battery cell. The separator, in particular, may include a relatively high porosity (e.g., 35% or higher porosity) and plays an important role in maintaining active material access to the electrolyte.

In certain types of batteries, such as cylindrical batteries, a jelly roll of the battery is formed by winding the positive electrode, the negative electrode, and the separator in a spiral-like configuration. However, the pores may be disposed in the separator while the separator is in an unwound state and prior to formation of the jelly roll. Winding of the separator during formation of the jelly roll may cause the pores to deform. This deformation of the pores in the separator may cause non-uniform electrolyte distribution, leading to battery degradation, reduced power capability, reduced longevity, etc.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment of the present disclosure, a separator of a battery cell includes first pores disposed through a first segment of a thickness of the separator, and second pores disposed through a second segment of the thickness. In an unwound state of the separator, a first cross-sectional area of the first pores differs in size from a second cross-sectional area of the second pores by a first amount. In a wound state of the separator, the first cross-sectional area is substantially equal in size to the second cross-sectional area, or the first cross-sectional area differs in size from the second cross-sectional area by a second amount that is less than the first amount.

In another embodiment of the present disclosure, a battery cell includes a first electrode, a second electrode, and a separator configured to be disposed between the first electrode and the second electrode. The separator includes first pores disposed through a first segment of a thickness of the separator, the first pores extending in a first direction transverse to the thickness. The separator also includes second pores disposed through a second segment of the thickness, the second pores extending in a second direction transverse to the thickness. In an unwound state of the separator, a first cross-sectional area of the first pores differs in size from a second cross-sectional area of the second pores by a first amount. In a wound state of the separator, the first cross-sectional area is substantially equal in size to the second cross-sectional area, or the first cross-sectional area differs in size from the second cross-sectional area by a second amount that is less than the first amount.

In yet another embodiment of the present disclosure, a separator includes a thickness, a first segment of the thickness, and first pores disposed in a first row through the first segment, where the first pores include a first total cross-sectional area when the separator is in an unwound state and a first additional total cross-sectional area when the separator is in a wound state. The separator also includes a second segment of the thickness and second pores disposed in a second row through the second segment, where the second pores include a second total cross-sectional area when the separator is in the unwound state and a second additional total cross-sectional area when the separator is in the wound state. The first total cross-sectional area differs in size from the second total cross-sectional area by a first amount, and the first additional total cross-sectional area is substantially the same in size as the second additional total cross-sectional area or differs in size from the second additional total cross-sectional area by a second amount that is less than the first amount.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a schematic cross-sectional overhead view of a battery cell including a first electrode, a second electrode, and a separator between the first electrode and the second electrode, according to embodiments of the present disclosure;

FIG. 2 is a schematic cross-sectional overhead view of the separator of the battery cell of FIG. 1 in an unwound state and including variable pore size, shape, geometry, and/or orientation, according to embodiments of the present disclosure;

FIG. 3 is a schematic cross-sectional overhead view of the separator of FIG. 2 in a wound state, according to embodiments of the present disclosure;

FIG. 4 is a schematic cross-sectional overhead view of the separator of the battery cell of FIG. 1 in an unwound state and including variable pore spacing and/or pore pattern, according to embodiments of the present disclosure;

FIG. 5 is a schematic cross-sectional overhead view of the separator of FIG. 4 in a wound state, according to embodiments of the present disclosure;

FIG. 6 is a schematic cross-sectional overhead view of the separator of the battery cell of FIG. 1 in an unwound state, the separator including multiple layers and variable pore size, shape, geometry, and/or orientation, according to embodiments of the present disclosure;

FIG. 7 is a schematic cross-sectional overhead view of the separator of FIG. 6 in a wound state, according to embodiments of the present disclosure;

FIG. 8 is a schematic cross-sectional overhead view of the separator of the battery cell of FIG. 1 in an unwound state and including variable porosity across a thickness and along a length of the separator, according to embodiments of the present disclosure;

FIG. 9 is a schematic cross-sectional overhead view of the separator of FIG. 8 in a wound state, according to embodiments of the present disclosure; and

FIG. 10 is a process flow diagram illustrating a method of manufacturing the battery cell of FIG. 1, according to embodiments of the present disclosure.

### DETAILED DESCRIPTION OF SPECIFIC EMBODIMENTS

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on. Additionally, the term “set” may include one or more. That is, a set may include a unitary set of one member, but the set may also include a set of multiple members.

This disclosure is generally directed to battery cells, such as secondary or rechargeable battery cells (e.g., lithium-ion battery cells, nickel manganese cobalt battery cells, nickel cobalt aluminum battery cells, nickel-metal hydride battery cells, nickel-cadmium battery cells, lithium iron phosphate battery cells, lithium-ion polymer battery cells, etc.). More specifically, the present disclosure is directed to porosity of a separator of the battery.

A battery cell includes at least a first electrode (e.g., positive electrode or anode), a second electrode (e.g., negative electrode or cathode), a separator between the first electrode and the second electrode, and electrolyte. During assembly of the battery cell, a jelly roll may be formed by the first electrode, the second electrode, and the separator. For example, the jelly roll may include a winding of the first electrode, the second electrode, and the separator in a spiral-like configuration. The jelly roll and an electrolyte may be disposed in an enclosure of the battery cell, where the electrolyte is configured to fill pores of the separator (and, in at least some embodiments, pores of the first electrode and the second electrode) to support ionic movement between the first and second electrode during charging and discharging of the battery cell.

The pores may be formed in the separator prior to the separator being installed in the battery cell (e.g., prior to formation of the jelly roll described above). That is, the pores may be formed in the separator while the separator is an unwound (e.g., uninstalled) state. As the jelly roll is formed by winding the first electrode, the second electrode, and the separator in the spiral-like configuration, the pores in the separator may be deformed (e.g., stretched, pinched, etc.). In accordance with the present disclosure, certain pore characteristics may be selectively varied across a thickness of the separator (e.g., while the separator is in the unwound state). The selective variation of such pore characteristics while the separator is in the unwound state may leverage the deformation in the pores caused by the winding of the separator in the jelly roll such that, after the jelly roll is formed and the pores have deformed, the resulting pore shapes, sizes, geometries, patterns, and/or cross-sectional areas are desirable.

For example, the thickness of the separator is configured to extend from the first electrode to the second electrode. When the separator is in the unwound state, a first segment of the thickness may include one or more first pore characteristic(s) (e.g., first pore size, first pore shape, first number of pores, first pore pattern, etc.), and a second segment of the thickness may include one or more second pore characteristic(s) (e.g., first pore size, first pore shape, first number of pores, first pore pattern, etc.) that differ(s) from the one or more first pore characteristic(s). Based on these differences, a first cross-sectional area of the pores in the first segment may differ (e.g., by a first amount) from a second cross-sectional area of the pores in the second segment while the separator is in the unwound state. For example, the first cross-sectional area may be greater than the second cross-sectional area by the first amount.

As the jelly roll is formed by winding the first electrode, the separator, and the second electrode into a spiral-like configuration, the first pores and/or the second pores may deform such that, upon formation of the jelly roll, the first cross-sectional area is substantially comparable (e.g., equal) in size to the second cross-sectional area, or such that the first cross-sectional area differs from the second cross-sectional area by a second amount that is less than the first amount. That is, the first cross-sectional area and the second cross-sectional area change (e.g., to a first additional cross-sectional area and a second additional cross-sectional area, respectively) in response to formation of the jelly roll (e.g. based on a curvature of the separator in the wound state). In other words, the first cross-sectional area of the first pores in the first segment of the thickness may be closer to the second cross-sectional area of the second pores in the second segment of the thickness in the wound (e.g., installed) state than in the unwound (e.g., uninstalled) state. In this way, uniformity in the electrolyte distribution through the thickness of the separator may be improved, which reduces a likelihood of battery cell degradation, improves a longevity of the battery, and/or improves a power capability of the battery cell, among other possible technical benefits. These and other aspects of the present disclosure are described in detail below with reference to the drawings.

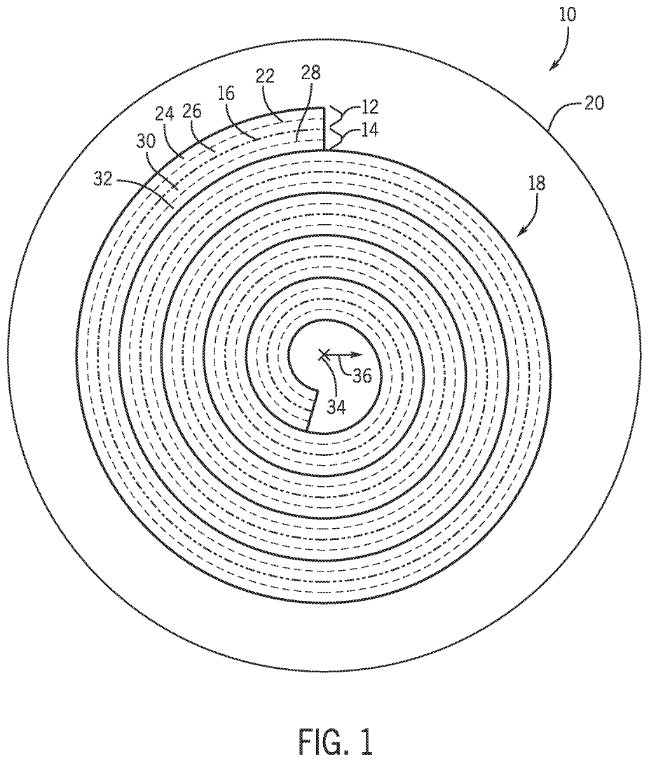

Turning now to the drawings, FIG. 1 is a schematic cross-sectional overhead view of an embodiment of a battery cell 10 including a first electrode 12 (e.g., positive electrode or anode), a second electrode 14 (e.g., negative electrode or cathode), and a separator 16 between the first electrode 12 and the second electrode 14. For example, the first electrode 12, the second electrode 14, and the separator 16 may be wound in a spiral-like configuration to form a jelly roll 18 of the battery cell 10, where the jelly roll 18 is disposed in an enclosure 20 of the battery cell 10. It should be noted that FIG. 1 is a schematic representation of the battery cell 10 and should not be taken to imply precise and/or relative dimensions of various aspects of the battery cell 10.

As shown, the first electrode 12 includes a first current collector 22 (e.g., anode foil) and first electrode active material 24, 26 (e.g., anode active material) on opposing sides of the first current collector 22. Further, the second electrode 14 includes a second current collector 28 (e.g., cathode foil) and second electrode active material 30, 32 (e.g., cathode active material) on opposing sides of the second current collector 28. Although not shown in the illustrated embodiment for purposes of brevity and clarity, the battery cell 10 may include tabs (e.g., an anode and a cathode tab) at opposing ends of the spiral-like configuration of the jelly roll 18, where the tabs are configured to be coupled to one or more terminals of the battery cell 10.

As shown, the jelly roll 18 forms a winding about an axis 34 (or axial direction) through a center of the battery cell 10. In accordance with the present disclosure, and as described in greater detail with reference to later drawings, the separator 16 may include pores extending in a direction substantially parallel to the axis 34 and substantially perpendicular to a radial direction 36 extending from the axis 34. For example, a thickness of the separator 16 extends between the first electrode 12 and the second electrode 14 along the radial direction 36.

In accordance with the present disclosure, when the separator 16 is in the illustrated wound (e.g., installed) state, cross-sectional areas of pores at certain segments of the separator 16 may be substantially comparable to each other. For example, a first cross-sectional area of first pores in a first segment of the thickness of the separator 16 and a second cross-sectional area of second pores in a second segment of the thickness of the separator 16, where the first segment is in contact with and disposed outward from the second segment along the radial direction 36, may be comparable when the separator 16 is in the wound state. This may be accomplished by selectively variable pore patterns, sizes, shapes, and the like implemented in the separator 16 when the separator 16 is in an unwound (e.g., uninstalled) state. For example, the pore pattern, size, shape, etc. may be varied between the first pores in the first segment of the thickness of the separator 16 and the second pores in the second segment of the thickness of the separator 16 while the separator is in the unwound state. These variances may leverage deformation (e.g., pinching, stretching, etc.) in the pores caused by transitioning the separator 16 from the unwound state to the wound state during formation of the jelly roll 18.

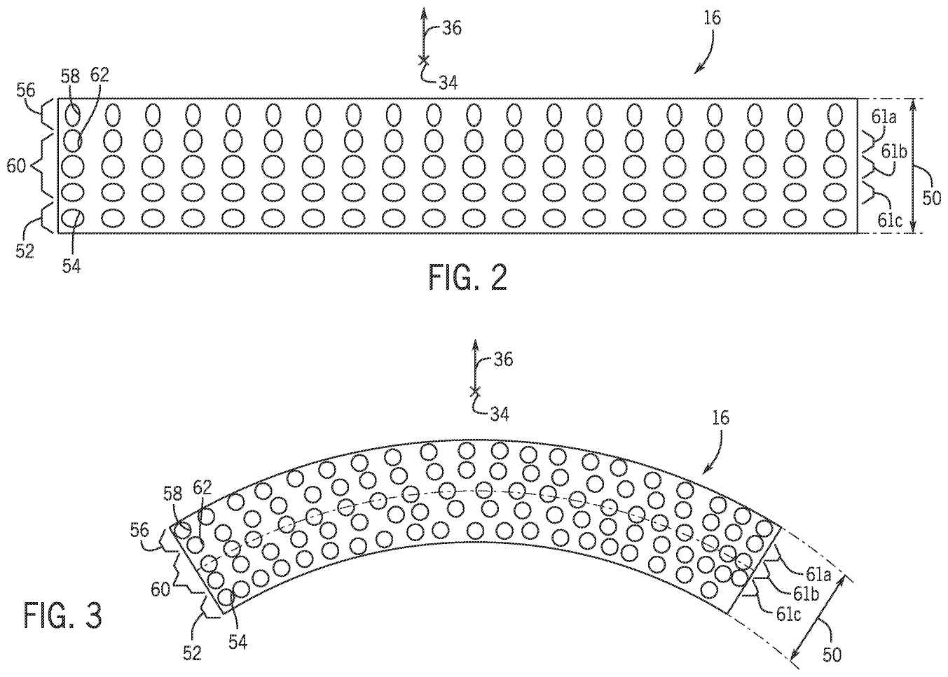

For example, FIGS. 2 and 3 are schematic cross-sectional overhead views of an embodiment of the separator 16 of the battery cell 10 of FIG. 1 in the unwound (e.g., uninstalled) state and the wound (e.g., installed) state, respectively. Focusing first on FIG. 2, the separator 16 includes a thickness 50 configured to extend, for example, from a first electrode to a second electrode. The thickness 50 of the separator 16 includes a first segment 52 corresponding to a first row of first pores 54, a second segment 56 corresponding to a second row of second pores 58, and a third segment 60 between the first segment 52 and the second segment 56, the third segment 60 corresponding to one or more third rows 61a, 61b, 61c of third pores 62. The various pores 54, 58, 62 extend in the axial direction 34 (e.g., transverse to the radial direction 36). That is, the illustrated perspective shows radially oriented cross-sections of the pores 54, 58, 62.

As shown in FIG. 2, the first pores 54 of the first segment 52 include first sizes that are greater than second sizes of the second pores 58 in the second segment 56. Additionally or alternatively, the first pores 54 in the first segment 52 may include a first shape or a first orientation of a shape, and the second pores 58 in the second segment 56 may include a second shape or a second orientation of the shape (e.g., where the second orientation is perpendicular to or otherwise transverse to the first orientation, such as first and second ovals having a 90-degree difference in orientation). In some embodiments, a first cross-sectional area of the first pores 54 is greater than a second cross-sectional area of the second pores 58. The first cross-sectional area of the first pores 54 is a total cross-sectional area of the first pores 54 (e.g., a sum of the cross-sectional areas of each pore of the first pores 54 in the first segment 52), and the second cross-sectional area of the first pores 54 is a total cross-sectional area of the second pores 58 (e.g., a sum of the cross-sectional areas of each pore of the second pores 58 in the second segment 56).

Further, the third pores 62 corresponding to the third segment 60 include third sizes that are less than the first sizes of the first pores 54 of the first segment 52 and greater than the second sizes of the second pores 58 of the second segment 56. Additionally or alternatively, a third shape of the third pores 62 may differ from first and second shapes of the first and second pores 54, 58, respectively. In some embodiments, a third cross-sectional area of the third pores 62 in the first row 61a of the third segment 60, for example, is less than the first cross-sectional area of the first pores 54 and greater than the second cross-sectional area of the second pores 58. That is, the third cross-sectional area may refer to a total cross-sectional area of the third pores 62 in a particular row, such as the first row 61a (e.g., a sum of the cross-sectional areas of each pore of the third pores 62 in the first row 61a).

As the separator 16 is transitioned from the unwound state in FIG. 2 to the wound state in FIG. 3, the first pores 54, the second pores 58, and/or the third pores 62 may deform. For example, the first pores 54 in the first segment 52 may be pinched or otherwise shrunk, and the second pores 58 in the second segment 56 may be stretched or otherwise expanded. In response to these deformations, the first cross-sectional area of the first pores 54 in the first segment 52 may be more closely aligned with the second cross-sectional area of the second pores 58 in the second segment 56 than when the separator 16 was in the unwound (e.g., uninstalled) state. Further, a third cross-sectional area of the third pores 62 in the first row 61a of the third segment 60 may be more closely aligned with the first cross-sectional area and the second cross-sectional area. The second row 61b and the third row 61c may be similarly affected. Based on the above-described structure and function, electrolyte distribution through the thickness 50 of the separator 16 may be relatively uniform, which may improve a performance, power capability, and/or longevity of the corresponding battery (e.g., the battery cell 10 in FIG. 1).

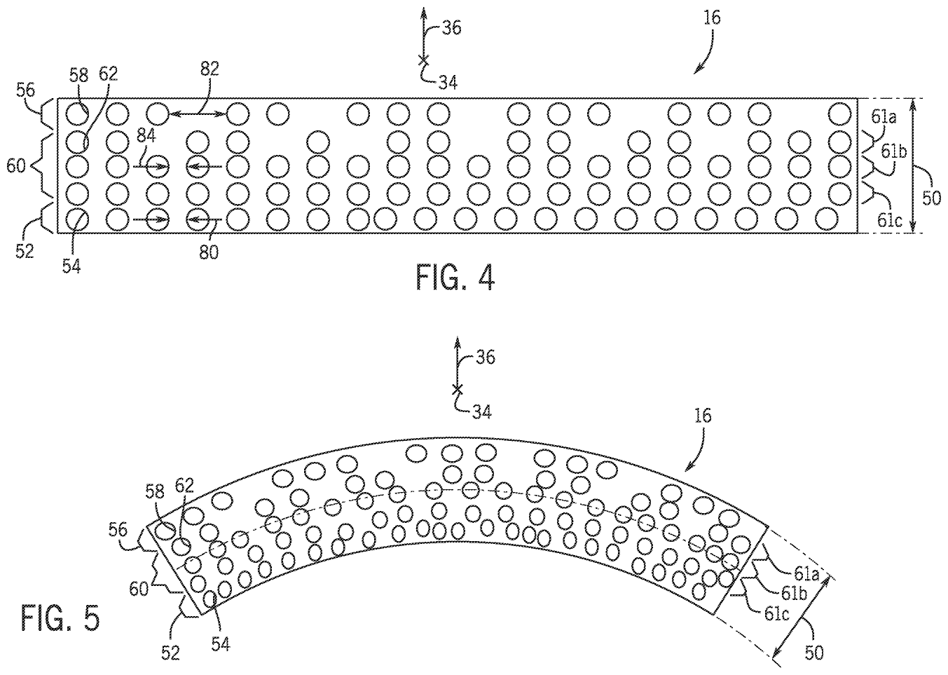

FIGS. 4 and 5 are schematic cross-sectional overhead views of an embodiment of the separator 16 of the battery cell 10 of FIG. 1 in the unwound (e.g., uninstalled) state and the wound (e.g., installed) state, respectively. As shown in FIG. 4, the first pores 54 of the first segment 52 of the thickness 50 of the separator 16 include a first pore pattern, the second pores 58 of the second segment 56 include a second pore pattern, and the first pore pattern differs from the second pore pattern. Additionally or alternatively, a first spacing 80 between certain first pores 54 of the first segment 52 may differ from a second spacing 82 between certain second pores 58 in the second segment 56. In this way, a first cross-sectional area of the first pores 54 of the first segment 52 differs from a second cross-sectional area of the second pores 58 of the second segment 56 with the separator 16 in the unwound state. Likewise, each row 61a, 61b, 61c of the third pores 62 in the third segment 60 includes a third pore pattern (and/or a third spacing 84 between certain adjacent third pores 62) that differs between the first pore pattern and/or the second pore pattern. In some embodiments, the third pore patterns of each row 61a, 61b, 61c may be varied. That is, the pore pattern in the first row 61a may differ from the pore pattern in the second row 61b and the third row 61c, and the pore pattern in the second row 61b may differ from the pore pattern in the third row 61c.

When the separator 16 is transitioned from the unwound state in FIG. 4 to the wound state in FIG. 5, the first and second cross-sectional areas of the first pores 54 in the first segment 52, respectively, may be more closely aligned than when the separator 16 was in the unwound state, as previously described. Likewise, the third cross-sectional area of the third pores 62 of the first row 61a of the third segment 60, for example, may be more closely aligned with the first cross-sectional area and the second cross-sectional area when the separator 16 is in the wound state. In this way, electrolyte distribution through the thickness 50 of the separator 16 is relatively uniform, thereby improving a performance, power capability, and/or longevity of the corresponding battery (e.g., the battery cell 10 in FIG. 1).

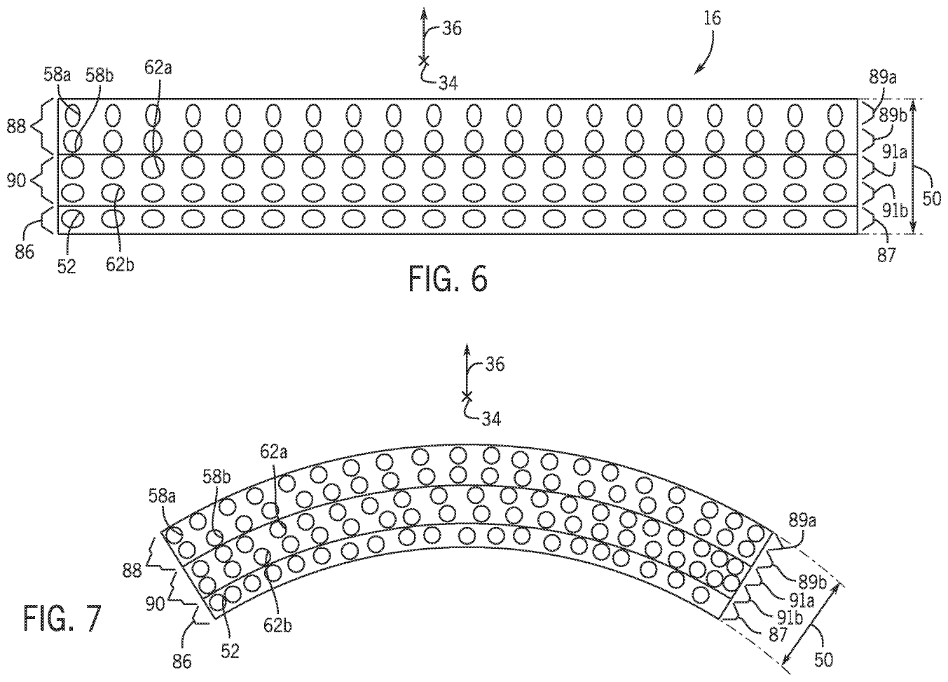

FIGS. 6 and 7 are schematic cross-sectional overhead views of an embodiment of the separator 16 of the battery cell 10 of FIG. 1 in the unwound (e.g., uninstalled) state and the wound (e.g., installed) state, respectively. FIGS. 6 and 7 are similar to FIGS. 2 and 3. However, FIGS. 2 and 3 are directed to a single layer embodiment of the separator 16 having multiple segments 52, 56, 60 on the single layer, whereas FIGS. 6 and 7 are directed to a multi-layer embodiment of the separator 16 (e.g., where each layer corresponds to one of the segments 52, 56, 60). It should be noted that use of “segment” or “segments” in the present disclosure does not necessarily denote a segment or segments of a single layer embodiment, but may also be used to refer to a segment or segments of a multi-layer embodiment. Further, pore structure in any single layer embodiment in the present disclosure may be employed in a multi-layer embodiment, and pore structure in any multi-layer embodiment in the present disclosure may be employed in a single layer embodiment. Distinctions between single layer and multi-layer embodiments are described in detail below.

In FIGS. 2 and 3, variable pore size, shape, pattern, spacing, or other porosity characteristic may be achieved by changing the particle size or size distribution of precursors (e.g., seeds) used in a wet manufacture process, where the seeds in a polymer (e.g., polyethylene) matrix are dissolved by special solvent to generate pores. In FIGS. 6 and 7, a dry method corresponding to manufacturing of the separator 16 may be employed, where no seeds and/or solvent is used. In FIGS. 6 and 7, variable pore size, shape, pattern, spacing, or other porosity characteristic may be achieved by stretching polymers (e.g., polyethylene) with special crystal structure. Such a dry method may employ a first layer 86 (e.g., corresponding to a row 87 of pores 54), a second layer 88 (e.g., corresponding to rows 89a, 89b of pores 58a, 58b, respectively), and a third (or intermediate) layer 90 (e.g., corresponding to rows 91a, 91b of pores 62a, 62b, respectively) of the separator 16.

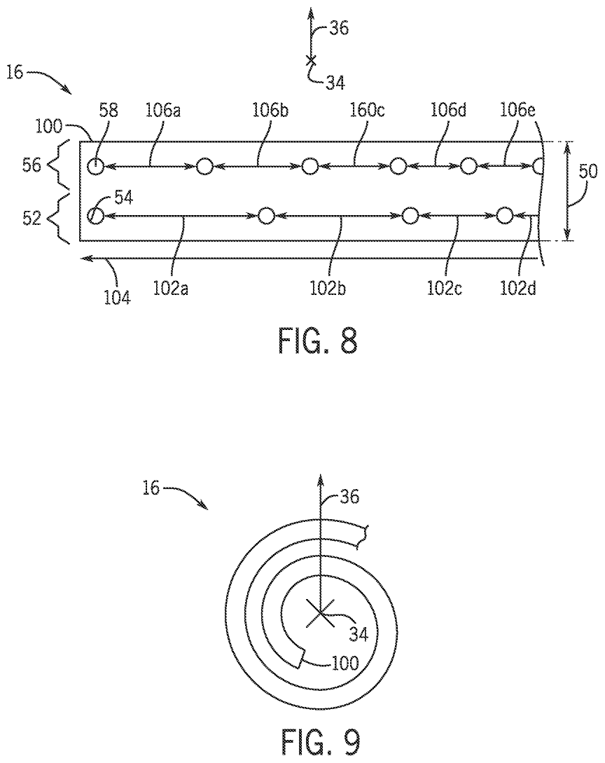

FIGS. 8 and 9 are schematic cross-sectional overhead views of an embodiment of the separator 16 of the battery cell 10 of FIG. 1 in an unwound state and a wound state, respectively. For purposes of brevity and clarity, FIG. 8 includes the first segment 52 of the thickness 50 of the separator 16 (e.g., including the first pores 54) and the second segment 56 of the thickness 50 of the separator 16 (e.g., including the second pores 58), but omits the third segment 60 described above with respect to FIGS. 2-7. Further, FIG. 9 is included to contextualize a location of an end 100 of the separator 16 and an effect of the spiral-like configuration of the separator 16 in the wound state, described in greater detail below. Accordingly, while the segments 52, 56 and corresponding pores 54, 58, respectively, are not shown in FIG. 9, it should be understood that the separator 16 in FIG. 9 includes such segments 52, 56 and pores 54, 58, respectively.

The separator 16 includes an end 100 that, as shown in FIG. 9, is configured to be disposed at a center of the spiral-like configuration formed by the separator 16 when the separator 16 is in the wound state. Focusing on FIG. 8, variable spacing 102a, 102b, 102c, 102d, etc. between adjacent instances of the first pores 54 of the first segment 52 is employed along a length 104 of the separator 16 (e.g., the length 104 extending transverse, such as substantially perpendicular, to the thickness 50). For example, the first spacing 102a is greater than the second spacing 102b, the second spacing 102b is greater than the third spacing 102c, the third spacing 102c is greater than the fourth spacing 102d, and so on and so forth. The progressively decreasing spacing 102a, 102b, 102c, 102d may account for an increasing radius, radius of curvature, or other radius or curvature characteristic of the separator 16 illustrated in FIG. 9. Indeed, a curvature of the separator 16 may be greater at the end 100 of the separator 16 than elsewhere (e.g., an opposing end) on the separator 16. Accordingly, the first pores 54 of the first segment 52 may be most widely spaced adjacent to the end 100 of the separator 16.

Likewise, as shown in FIG. 8, variable spacing 106a, 106b, 106c, 106d, 106e, etc. between adjacent instances of the second pores 58 of the second segment 56 is employed along the length 104 of the separator 16. For example, the first spacing 106a is greater than the second spacing 106b, the second spacing 106b is greater than the third spacing 106c, the third spacing 106c is greater than the fourth spacing 106d, the fourth spacing 106d is greater than the fifth spacing 106e, and so on and so forth. The progressively decreasing spacing 106a, 106b, 106c, 106d, 106e may account for an increasing radius, radius of curvature, or other radius or curvature characteristic of the separator 16 illustrated in FIG. 9. Indeed, a curvature of the separator 16 may be greater at the end 100 of the separator 16 than elsewhere (e.g., an opposing end) on the separator 16. Accordingly, the second pores 58 of the second segment 56 may be most widely spaced adjacent to the end 100 of the separator 16. In this way, electrolyte distribution through the length 104 of the separator 16 may be relatively uniform, thereby reducing battery degradation, improving battery performance and/or power capability, improving longevity, etc.

As shown in FIG. 8, the pore spacing of the first pores 54 of the first segment 52 may also differ from the pore spacing of the second pores 58 of the second segment 56. For example, the first spacing 102a in the first segment 52 is greater than the first spacing 106a in the second segment 56, the second spacing 102b in the first segment 52 is greater than the second spacing 106b in the second segment 56, the third spacing 102c in the first segment 52 is greater than the third spacing 106c in the second segment 56, the fourth spacing 102d in the first segment 52 is greater than the fourth spacing 106d in the second segment 56, and so on and so forth. As previously described, such an arrangement may enable relatively uniform electrolyte distribution through the thickness 50 of the separator 16, thereby reducing battery degradation, improving battery performance and/or power capability, improving longevity, etc.

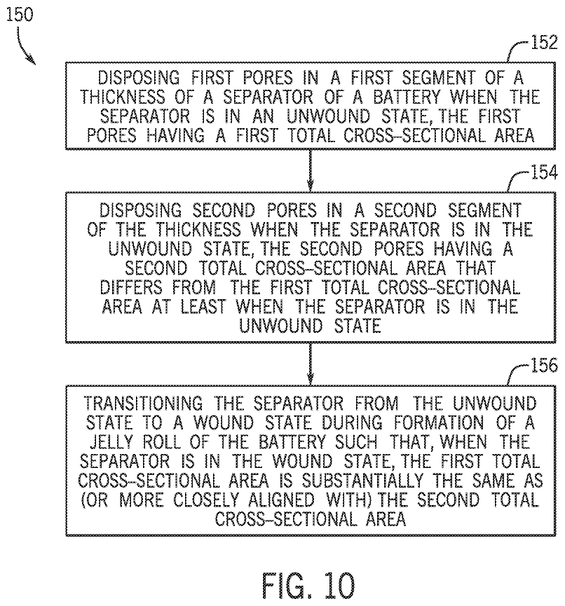

FIG. 10 is a process flow diagram illustrating an embodiment of a method 150 of manufacturing the battery cell of FIG. 1. In the illustrated embodiment, the method 150 includes disposing (block 152) first pores in a first segment of a thickness of a separator of a battery when the separator is in an unwound state, the first pores having a first cross-sectional area. The method 150 also includes disposing (block 154) second pores in a second segment of the thickness when the separator is in the unwound state, the second pores having a second cross-sectional area, and the second cross-sectional area differing from the first cross-sectional area. For example, variable sizes, shapes, spacing, patterns, etc. may be employed in the pores such that the first cross-sectional area differs from the second cross-sectional area.

The method 150 also includes transitioning (block 156) the separator from the unwound state to a wound state during formation of a jelly roll (e.g., including the separator and first and second electrodes) of the battery such that, when the separator is in the wound state, the first cross-sectional area is substantially the same as (or more closely aligned with) the second cross-sectional area. In other words, the first cross-sectional area is closer to the second cross-sectional area when the separator is in the wound state than when the separator is in the unwound state. In this way, electrolyte distribution in the separator and corresponding battery is relatively uniform, thereby reducing battery degradation, improving battery performance, improving power capability of the battery, and/or increasing a longevity of the battery.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A separator of a battery cell, the separator comprising:
a first plurality of pores disposed through a first segment of a thickness of the separator; and
a second plurality of pores disposed through a second segment of the thickness, wherein:
in an unwound state of the separator, a first cross-sectional area of the first plurality of pores differs in size from a second cross-sectional area of the second plurality of pores by a first amount; and
in a wound state of the separator, the first cross-sectional area is substantially equal in size to the second cross-sectional area, or the first cross-sectional area differs from the second cross-sectional area in size by a second amount that is less than the first amount.

2. The separator of claim 1, wherein a first shape of each first pore of the first plurality of pores differs from a second shape of each second pore of the second plurality of pores at least when the separator is in the unwound state.

3. The separator of claim 1, wherein a first spacing between adjacent first pores of the first plurality of pores differs from a second spacing of adjacent second pores of the second plurality of pores at least when the separator is in the unwound state.

4. The separator of claim 1, wherein a first amount of pores of the first plurality of pores differs from a second amount of pores of the second plurality of pores.

5. The separator of claim 1, wherein a first pore pattern of the first plurality of pores differs from a second pore pattern of the second plurality of pores at least when the separator is in the unwound state.

6. The separator of claim 1, wherein the first segment is configured to extend adjacent to a first battery cell electrode, and the second segment is configured to extend adjacent to a second battery cell electrode.

7. The separator of claim 1, comprising a third plurality of pores disposed through a third segment of the thickness, wherein the third segment extends between the first segment and the second segment, and a third cross-sectional area of the third plurality of pores differs from the first cross-sectional area and the second cross-sectional area at least when the separator is in the unwound state.

8. The separator of claim 7, wherein:
the first plurality of pores of the first segment are disposed in a first row extending along a length of the separator transverse to the thickness of the separator;
the second plurality of pores of the second segment are disposed in a second row extending along the length; and
the third plurality of pores of the third segment are disposed in a third row extending along the length.

9. The separator of claim 7, wherein the first cross-sectional area is greater than the third cross-sectional area at least when the separator is in the unwound state, and the third cross-sectional area is greater than the second cross-sectional area at least when the separator is in the unwound state.

10. The separator of claim 1, wherein:
in the unwound state of the separator, the first cross-sectional area is greater than the second cross-sectional area of the second plurality of pores by the first amount; and
in the wound state of the separator, a first curvature of the first segment is disposed inwardly from a second curvature of the second segment.

11. A battery cell, comprising:
a first electrode;
a second electrode; and
a separator configured to be disposed between the first electrode and the second electrode, wherein the separator comprises:
a first plurality of pores disposed through a first segment of a thickness of the separator, the first plurality of pores extending in a first direction transverse to the thickness; and
a second plurality of pores disposed through a second segment of the thickness, the second plurality of pores extending in a second direction transverse to the thickness, wherein:
in an unwound state of the separator, a first cross-sectional area of the first plurality of pores differs in size from a second cross-sectional area of the second plurality of pores by a first amount; and
in a wound state of the separator, the first cross-sectional area is substantially equal in size to the second cross-sectional area, or the first cross-sectional area differs in size from the second cross-sectional area by a second amount that is less than the first amount.

12. The battery cell of claim 11, wherein each first pore of the first plurality of pores comprises a first characteristic, each second pore of the second plurality of pores comprises a second characteristic, and the first characteristic differs from the second characteristic at least when the separator is in the unwound state.

13. The battery cell of claim 12, wherein:
the first characteristic comprises a first shape or first orientation of a shape; and
the second characteristic comprises a second shape or a second orientation of the shape.

14. The battery cell of claim 11, wherein:
the first plurality of pores comprises a first pore pattern; and
the second plurality of pores comprises a second pore pattern, wherein the first pore pattern differs from the second pore pattern at least when the separator is in the unwound state.

15. The battery cell of claim 11, wherein:
adjacent first pores of the first plurality of pores are separated by a first pore spacing; and
adjacent second pores of the second plurality of pores are separated by a second pore spacing, wherein the first pore spacing differs from the second pore spacing at least when the separator is in the unwound state.

16. A separator, comprising:
a thickness;
a first segment of the thickness and a first plurality of pores disposed in a first row through the first segment, wherein the first plurality of pores comprises a first total cross-sectional area when the separator is in an unwound state and a first additional total cross-sectional area when the separator is in a wound state;
a second segment of the thickness and a second plurality of pores disposed in a second row through the second segment, wherein the second plurality of pores comprises a second total cross-sectional area when the separator is in the unwound state and a second additional total cross-sectional area when the separator is in the wound state, wherein the first total cross-sectional area differs in size from the second total cross-sectional area by a first amount, and wherein the first additional total cross-sectional area is substantially the same in size as the second additional total cross-sectional area or differs in size from the second additional total cross-sectional area by a second amount that is less than the first amount.

17. The separator of claim 16, comprising a third segment of the thickness and a third plurality of pores disposed in a third row through the third segment, wherein:
the third segment is between the first segment and the second segment; and
the third plurality of pores comprises a third total cross-sectional area that is greater than the second total cross-sectional area and less than the first total cross-sectional area when the separator is in the unwound state.

18. The separator of claim 16, comprising:
a first separator layer corresponding to the first segment; and
a second separator layer corresponding to the second segment and being physically separate from the first separator layer.

19. The separator of claim 16, wherein the separator comprises a layer having the first segment and the second segment.

20. The separator of claim 16, wherein the first plurality of pores differ from the second plurality of pores in size, shape, spacing, pattern, orientation, or any combination thereof.
